(19) United States
(12) Patent Application Publication
(10) Pub. No.: US 2005/0207612 A1
(43) Pub. Date: Sep. 22, 2005

(54) Loudspeaker with a first and a second diaphragm body

(76) Inventor: Guido Odilon Maurits D'Hoogh, Dendermonde (BE)

Correspondence Address: PHILIPS INTELLECTUAL PROPERTY & STANDARDS, P.O. BOX 3001, BRIARCLIFF MANOR, NY, 10510, US

(21) Appl. No.: 10/511,973

(22) PCT Filed: Apr. 25, 2003
(86) PCT No.: PCT/IB03/01845

§ 371 Date: Oct. 20, 2004

(30) Foreign Application Priority Data
Apr. 25, 2002 (EP) 02076651.5

(51) Int. Cl. H04R 25/00

(52) U.S. Cl. 381/423; 381/424

(57) ABSTRACT

Loudspeaker provided with a frame (2), a diaphragm (4) and an electric driving means for moving the diaphragm along an axis of translation (8) with respect to the frame. The diaphragm runs round the axis of translation and includes an outer conical first diaphragm body (4A) and an inner conical second diaphragm body (4B) which is invertedly oriented with respect to and positioned inside the first diaphragm body. These bodies each have a base portion and a top portion, the top portion (4At) of the first diaphragm body and the base portion (4Bb) of the second diaphragm body being interconnected. The diaphragm is suspended from the frame through a first flexible suspension means (14) extending between the base portion (4Ab) of the first diaphragm body and the frame and through a second flexible suspension means (16) extending between the top portion of the first diaphragm body and the frame. The top portion (4Bt) of the second diaphragm body is attached to a movable part (6M) of the driving means. Due to this suspension arrangement in combination with the specific form of the diaphragm a very small height of the loudspeaker is within reach.

The invention relates to a loudspeaker provided with a frame, a diaphragm and an electric driving means for moving the diaphragm along an axis of translation with respect to the frame, which diaphragm runs round the axis of translation and includes an outer conical first diaphragm body and an inner conical second diaphragm body which is invertedly oriented with respect to and positioned inside the first diaphragm body, each body having a base portion and a top portion, the top portion of the first diaphragm body and the base portion of the second diaphragm body being interconnected, and which electric driving means includes a stationary part connected to the frame and a movable part.

JP-A 0 820 52 83 discloses a loudspeaker having a diaphragm including an outside cone part and an inverted inside cone part coupled in a coupling part to the outside cone part. A voice coil bobbin is joined to the inside cone part. The diaphragm is suspended from a frame by means of a flexible suspension ring fixed to the largest circumferential rim of the outside cone part and the frame and a flexible centering element attached to the frame and a middle portion of the voice coil bobbin. Although due to the applied diaphragm the height of the known loudspeaker may be smaller than the height of generally known loudspeakers provided with single conical diaphragms, this known speaker has still a relatively large height owing to the required relatively long voice coil bobbin.

It is an object of the invention to improve the loudspeaker as defined in the preamble in such a way that a very small height is within reach.

This object is achieved by the loudspeaker according to the invention, which is provided with a frame, a diaphragm and an electric driving means for moving the diaphragm along an axis of translation with respect to the frame, which diaphragm runs round the axis of translation and includes an outer conical first diaphragm body and an inner conical second diaphragm body which is invertedly oriented with respect to and positioned inside the first diaphragm body, each body having a base portion and a top portion, the top portion of the first diaphragm body and the base portion of the second diaphragm body being interconnected, and which electric driving means includes a stationary part connected to the frame and a movable part, wherein the diaphragm is suspended from the frame through a first flexible suspension means extending between the base portion of the first diaphragm body and the frame and through a second flexible suspension means extending between the top portion of the first diaphragm body and/or the base portion of the second diaphragm body on the one hand and the frame or a mechanical structure fixed to the frame on the other hand and wherein the top portion of the second diaphragm body is attached to the movable part of the driving means. Due to this suspension arrangement the moving part of the driving means of the loudspeaker can be surprising short, i.e. the axial dimension of the moving part, thus the dimension considered along the axis of translation, can be small. This means that the required built-in depth is also small. For this reason the loudspeaker according to the invention is very suitable for applications in which flat devices are desired or required. Such applications can be found e.g. in the automotive field.

In a practical embodiment the driving means is positioned opposite to the second diaphragm body and at least partly inside the first diaphragm body. Generally, the stationary part of the driving means, also referred to as electromagnetic actuator, includes a magnetic yoke with a permanent magnet and the movable part of the driving means includes a driving coil, also referred to as voice coil, for magnetical co-operation with the magnetic yoke. Thus, the driving coil is situated in the magnetic field of the magnet.

A preferred embodiment of the loudspeaker according to the invention is characterized in that the first flexible suspension means is attached to the first diaphragm body on the one hand and the frame or a mounting element fixed to the frame on the other hand.

The first flexible suspension means may be a flexible structure with an undulation or wrinkle. Such a structure may be, for example, a corrugated rubber annular rim.

In general the second flexible suspension means is a radial bearing means, also referred to as centring means, particularly centring ring or spider. This means serves to guarantee an accurate alignment of the diaphragm with respect to the frame and may be in the form of a flexible structure of, for example, rubber, synthetic material and/or textile.

A further preferred embodiment of the loudspeaker according to the invention is characterized in that the second flexible suspension means is attached to the first and/or second diaphragm body on the one hand and the frame or the mechanical structure fixed to the frame on the other hand. In this context it is noted that mechanical structure is a stiff structure which may include a mounting element that may be secured to or include the stationary part of the driving means. Preferably, the mounting element comprises a central support located at the axis of translation of the diaphragm and at least partly positioned inside the diaphragm.

Although the diaphragm can be constituted by two separate diaphragm bodies, it may be favourable, for example for manufacturing reasons, if the first diaphragm body and the second diaphragm body form an integral diaphragm body. The material of the diaphragm may be conventional pressed paper, injection molded plastics or deep-drawn plastics, such as polycarbonate, polypropylene.

The invention also relates to a loudspeaker unit provided with an enclosure and a built-in loudspeaker according to the invention.

With reference to the claims, it is to be noted that various characteristic features as defined in the set of claims may occur in combination.

The above-mentioned and other aspects of the invention are apparent from and will be elucidated, by way of non-limitative example, with reference to the embodiments described hereinafter.

In the drawings:

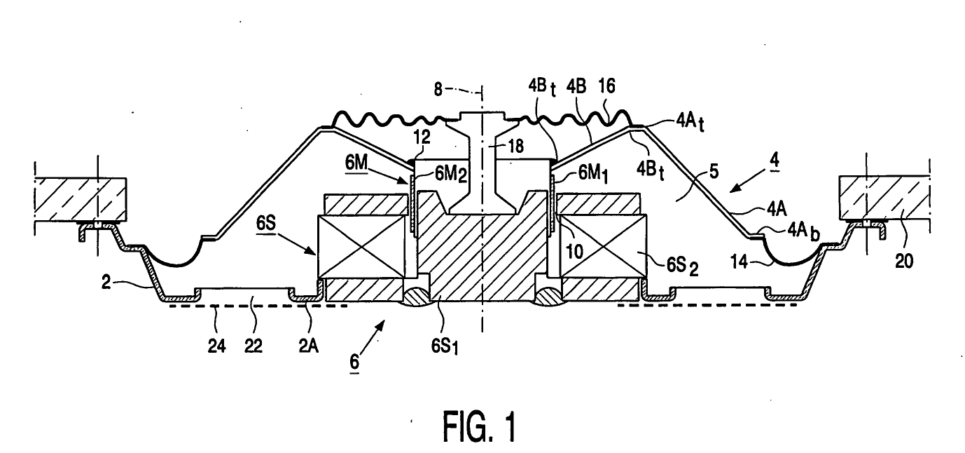

FIG. 1 shows a first embodiment of the loudspeaker according to the invention in a diagrammatic cross-section,

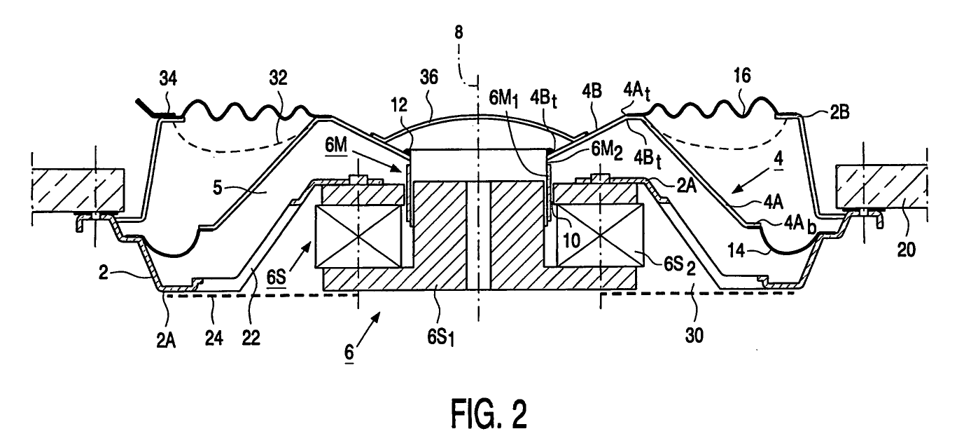

FIG. 2 shows a second embodiment of the loudspeaker according to the invention in a diagrammatic cross-section and

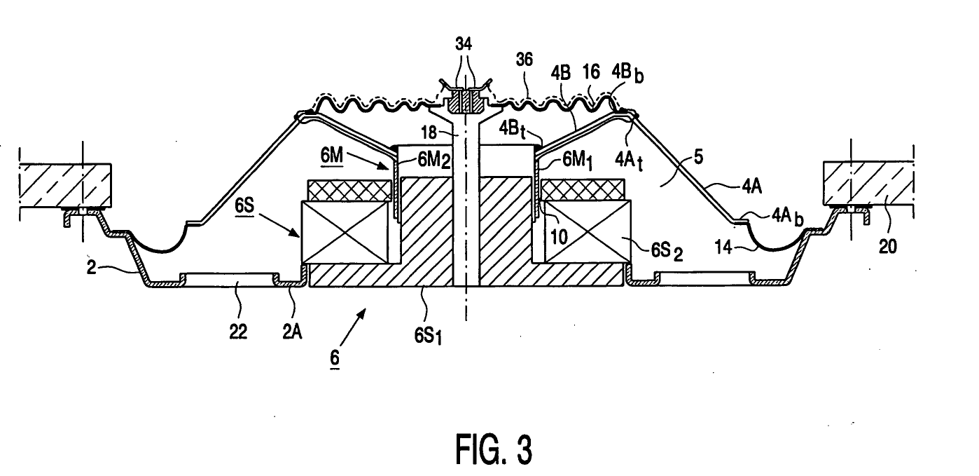

FIG. 3 shows a third embodiment of the loudspeaker according to the invention in a diagrammatic cross-section.

The electrodynamic loudspeaker according to the invention, shown in FIG. 1, includes a frame or chassis 2, a diaphragm 4 and an electromagnetic actuator 6 for moving the diaphragm 4 along an axis of translation 8 with respect to the frame 2. The diaphragm 4 comprises two conical bodies, viz. an outer conical first diaphragm body 4A and an inner conical diaphragm body 4B which bodies are invertedly oriented with respect to each other. The first diaphragm 4A has a base portion 4Ab and a top portion 4At. The second diaphragm 4B has a base portion 4Bb and a top portion 4Bt, the top portion 4At and the base portion 4Bb being mutually connected. In this example the conical bodies 4A and 4B form an integral whole, i.e. the diaphragm 4, the top portion 4At and the base portion 4Bt coinciding. The actuator 6, which is also referred to as electric driving means in this document, includes a stationary part 6S connected to the frame 2 and a movable part 6M connected to the diaphragm 4. The stationary part 6S, which is fixed to a mounting plate 2A of the frame 2 by means of e.g. folding, has a magnetic yoke 6S1 and a permanent magnet 6S2. Due to the space 5 created by the diaphragm 4 a relatively large stationary part 6S can be applied, so that not only compact, expensive neodymium magnets, but also conventional and thus cheap magnets of e.g. ferrite can be used. The movable part 6M, which is translatable along the axis 8 with respect to the stationary part 6S, has a driving coil 6M1, also referred to as voice coil, and a tubular coil support 6M2 supported by the coil 6M1. Upon energization the driving coil 6M1 magnetically co-operates over an air gap 10 with the magnet 6S2. The coil support 6M2 has an end portion 12 which is situated outside the gap 10. The top portion 4Bt of the second diaphragm body 4B is attached to this end portion 12 by means of e.g. an adhesive. The diagram 4 is suspended from the frame 2 by means of a flexible corrugated annular rim 14 of e.g. rubber, which rim is also referred to in this document as first flexible suspension means. The rim 14 is attached to the base portion 4Ab of the diaphragm body 4A, e.g. by means of an adhesive, and is further fixed to the frame 2. An undulating centring spider 16, also referred to as second flexible suspension means in this document, is provided in or near the plane defined by the top portion 4At of the first diaphragm body 4A and the base portion 4Bb of the second diaphragm body 4B. The spider 16 is attached to the diaphragm 4, at the location of the top portion 4At and the base portion 4Bb, by means of e.g. an adhesive. The spider 16 is further fixed to a central mounting element 18. This mounting element 18 is fixed to the soft-magnetic yoke 6S1 and via this yoke 6S1 secured to the frame 2. Thus, the mounting element 18 and the yoke 6S1 together form a stiff mechanical structure fixed to the frame 2. The frame 2 may be secured to a wall 20 of a loudspeaker box or a built-in opening.

From FIG. 1 it will be clear that the backside of the loudspeaker according to the invention is formed by the second flexible suspension means. The front side of the loudspeaker may be provided with sound apertures 22, which may be covered by a grid 24, a piece of fabric or something like that.

Reference is now made to the FIGS. 2 and 3. The features of the embodiments of these Figures which are identical to the corresponding features of the embodiment of FIG. 1 are allocated the same reference numerals and will not be further described in detail.

In the loudspeaker according to the invention shown in FIG. 2 the frame 2 is provided with a concave mounting plate 2A to with the stationary part 6S of the actuator 6 is secured. This alternative construction provides a space 30 in which the stationary part 6S of different types can be accommodated, without the necessary to adapt other parts of the loudspeaker. The second flexible suspension means 16 extends between the top portion 4At (or the base portion 4Bb) and a frame 2B of the frame 2 and is fixed to the portion 4At (or 4Bb) and the frame part 2B. Electric wires 32 are led along the second conical diaphragm body 4B and fixed to electric contact elements 34 which are insulated from and secured to the frame 2. A dust cap 36 is provided for acoustical reasons and for protection the gap 10 against unwanted particles.

The loudspeaker shown in FIG. 3 is provided with electric contact lips 34 attached to the central mounting element 18. The mounting element 18 is mounted in the yoke 6S1 and via the stationary part 6S secured to the frame 2. Flexible current conductors 36, which are integrated in the undulating structure of the second suspension means 16, are soldered to the lips 34 and the coil 6M1. These integrated conductors 36 are rather insensible to damages.

It is to be noted that the invention is not restricted to the embodiments disclosed. For example, the diaphragm 4 may be made from two separate conical bodies 4A and 4B which are joined together during manufacture in such a way that their portions 4At and 4Bb are fastened to each other, e.g. by means of a glue.

1. Loudspeaker provided with a frame, a diaphragm and an electric driving means for moving the diaphragm along an axis of translation with respect to the frame, which diaphragm runs round the axis of translation and includes an outer conical first diaphragm body and an inner conical second diaphragm body which is invertedly oriented with respect to and positioned inside the first diaphragm body, each body having a base portion and a top portion, the top portion of the first diaphragm body and the base portion of the second diaphragm body being interconnected, and which electric driving means includes a stationary part connected to the frame and a movable part, wherein the diaphragm is suspended from the frame through a first flexible suspension means extending between the base portion of the first diaphragm body and the frame and through a second flexible suspension means extending between the top portion of the first diaphragm body and/or the base portion of the second diaphragm body on the one hand and the frame or a mechanical structure fixed to the frame on the other hand, and wherein the top portion of the second diaphragm body is attached to the movable part of the driving means.

2. Loudspeaker as claimed in claim 1, wherein the driving means is positioned opposite to the second diaphragm body and at least partly inside the first diaphragm body.

3. Loudspeaker as claimed in claim 1, wherein the stationary part of the driving means includes a magnetic yoke with a permanent magnet and the movable part of the driving means includes a driving coil for an electromagnetical cooperation with the magnetic yoke.

4. Loudspeaker as claimed in claim 1, wherein the first flexible suspension means is attached to the first diaphragm body on the one hand and the frame or a mounting element fixed to the frame on the other hand.

5. Loudspeaker as claimed in claim 1, wherein the second flexible suspension means is a radial bearing means.

6. Loudspeaker as claimed in claim 1, wherein the second flexible suspension means is attached to the first and/or second diaphragm body on the one hand and the frame or the mechanical structure fixed to the frame on the other hand.

7. Loudspeaker as claimed in claim 6, wherein the mechanical structure includes a mounting element secured to the stationary part of the driving means.

8. Loudspeaker as claimed in claim 6, wherein the mounting element comprises a central support located at the axis of translation of the diaphragm and at least partly positioned inside the diaphragm.

9. Loudspeaker as claimed in claim 1, wherein the first diaphragm body and the second diaphragm body form an integral diaphragm body.

10. Loudspeaker unit provided with an enclosure and a built-in loudspeaker according to claim 1.
